(19) United States
(12) Patent Application Publication
(10) Pub. No.: US 2024/0033770 A1
(43) Pub. Date: Feb. 1, 2024

(54) System And Method For Applying A Coating Material To A Web

(71) Applicant: Graphic Packaging International, LLC, Atlanta, GA (US)

(72) Inventors: Phillip Kenzlo, Loveland, CO (US); Alan Fontaine, Louisville, CO (US); Jeffrey T. Sloat, Broomfield, CO (US)

(21) Appl. No.: 18/226,376

(22) Filed: Jul. 26, 2023

Related U.S. Application Data
(60) Provisional application No. 63/392,520, filed on Jul. 27, 2022.

(51) Int. Cl. B05C 5/02; B05C 5/00

(52) U.S. Cl. CPC B05C 5/0254; B05C 5/001

(57) ABSTRACT

A method for forming a coated material. The method can comprise heating a coating material to a temperature within an operating window and moving the coating material through a heated hose to a slot die having a die outlet. The method further can include outputting the coating material from the slot die through the die outlet and conveying a web of material past the die outlet of the slot die to apply the coating material from the die outlet along at least a portion of a surface of the web of material as the web of material moves past the die outlet.

### ROSS-REFERENCED TO RELATED APPLICATIONS

This application claims the benefit of U.S. Provisional Patent Application No. 63/392,520, filed on Jul. 27, 2022.

### INCORPORATION BY REFERENCE

The disclosure of U.S. Provisional Patent Application No. 63/392,520, which was filed on Jul. 27, 2022, is hereby incorporated by reference for all purposes as if presented herein in its entirety.

### BACKGROUND OF THE DISCLOSURE

The present disclosure generally relates to systems and methods for making a coated material (e.g., for making packaging materials) that may include a fibrous base material (e.g., paperboard or other suitable materials) and a coating or film formed on the base material. In embodiments, the present disclosure relates to systems and methods of applying a coating material to a web of material, wherein the coating material comprises a polymer with a narrow thermal operating window (e.g., a biodegradable polymer).

In examples, a coating material (e.g., a polymer) can be applied directly to a web of material (e.g., without glues, adhesives, heat seal layers, etc.) to form a coated web by heating the coating material to a temperature within an operating window (e.g., to melt the coating material) and applying the coating material to a surface of the web of material, such as in a curtain. It can be difficult to maintain a stable curtain for materials with a narrow thermal processing window, and an unstable or inconsistent curtain of coating material can result in coating layers that are not uniform and/or can leave uncoated portions of the web. For example, if the operating temperature of the coating material is too high, the material can degrade and cause the curtain to lose stability and/or higher temperatures can cause the viscosity of the material to drop and break the curtain. If the operating temperature of the coating material is too low, adhesion between the coating material and the substrate can be reduced. In addition, the coating material can lose heat while falling in the curtain, which can lead to reduced adhesion between the coating material and the web. In examples, a chill roll may be needed for extrusion curtain coating applications and biodegradable resins can have problems with wrapping at the nip of the chill roll.

### SUMMARY OF THE DISCLOSURE

In general, one aspect of the disclosure is directed to a method for forming a coated material. The method can comprise heating a coating material to a temperature within an operating window and moving the coating material through a heated hose to a slot die having a die outlet. The method further can include outputting the coating material from the slot die through the die outlet and conveying a web of material past the die outlet of the slot die to apply the coating material from the die outlet along at least a portion of a surface of the web of material as the web of material moves past the die outlet.

In another aspect, the disclosure is generally directed to a system for forming a coated material. The system can include a heating station for heating a coating material to a temperature within an operating window, a slot die comprising a die outlet for outputting the coating material from the slot die, a heated hose in fluid communication with the heating station and the slot die for moving the coating material from the heating station to the slot die, and a conveyor positioned relative to the die outlet of the slot die for conveying a web of material past the die outlet.

Those skilled in the art will appreciate the above stated advantages and other advantages and benefits of various additional embodiments reading the following detailed description of the embodiments with reference to the below-listed drawing figures.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the disclosure. The drawings are schematic and exemplary only and should not be construed as limiting the invention.

FIG. 1 is a schematic side view of a system for forming a coated material in accordance with exemplary embodiments of the disclosure.

FIGS. 2A-2D are views of various portions of the system of FIG. 1.

FIG. 3 is a view of a slot die of the system of FIG. 1.

FIGS. 4A and 4B are views showing the slot die of FIG. 3 applying a coating material to a web of material in accordance with exemplary embodiments of the disclosure.

FIG. 5 is a schematic side view of a portion of an alternative system for forming a coated material in accordance with exemplary embodiments of the disclosure.

FIGS. 6A-6D are exemplary flow charts of respective processes in accordance with embodiments of the disclosure.

Corresponding parts are designated by corresponding reference numbers throughout the drawings.

### DETAILED DESCRIPTION OF THE EXEMPLARY EMBODIMENTS

Exemplary embodiments of this disclosure are described below and illustrated in the accompanying figures, in which like numerals refer to like parts throughout the several views. The embodiments described provide examples and should not be interpreted as limiting the scope of the invention. Other embodiments, and modifications and improvements of the described embodiments, will occur to those skilled in the art and all such other embodiments, modifications and improvements are within the scope of the invention.

One aspect of this disclosure is the provision of systems and methods for providing a web of coated material. In embodiments, the web of coated material can be a packaging material or can be further formed into a packaging material, wherein the packaging material may be formed into a tray, a carton, and/or another suitable container or construct for holding and/or packaging one or more articles (e.g., for storage, heating, transporting, and/or use). In one example, the web of material or substrate can be a paperboard web or other suitable paper-based material or other suitable fiber-based material or other suitable material, and the coating material can be a material (e.g., a thermoplastic polymer) with a narrow thermal operating window and/or can be a biodegradable polymer or other suitable material. In exemplary embodiments, the substrate can be Ahlstrom-Munksjö 40# NK paper. In exemplary embodiments, the coating material can be a polyhydroxyalkanoate (PHA). In embodiments, the coating material can comprise poly(lactic acid) (PLA), Polybutylene succinate (PBS), polybutylene adipate terephthalate (PBAT), thermoplastic starches, PHA, and combinations thereof. In embodiments, blending polymers to form the coating material can help improve processing characteristics of the coating material, but can have trade-offs. For example, adding PLA to PHA can have better processing characteristics than PHA alone; however, the PLA can reduce the degradability of the coating material in marine environments. In some examples, the coating material could be PHA with 15% CaCO₃ and an adhesion promoter, PHA with 15% CaCO₃, PHA with PLA, or PHA alone.

In embodiments, a material may have a desired operating window in which the material is melted and has a desired viscosity (e.g., for moving the material through conduits, dies, etc., and/or for achieving adhesion to surfaces, and/or for achieving coating thicknesses on a substrate). In exemplary embodiments, a material, such as PHA, may have an operating window of approximately 25° C., e.g., from a melting temperature of approximately 175° C. to a temperature of approximately 200° C. over which the material may experience problems, such as over-oxidation, curtain instability (e.g., in curtain coating processes), increased sticking to a chill roll (e.g., due to the resin breaking down), etc. A material, such as a coating grade low density polyethylene or other suitable material, that does not have a narrow operating window may have a wider operating window, such as of approximately 210 to 220° C. (e.g., from a melting temperature of approximately 105 to 113° C. to processing temperatures of approximately 310 to 335° C. in which the resin may start to experience problems, such as over-oxidation), but may lack other desirable properties (e.g., degradability in certain environments, etc.).

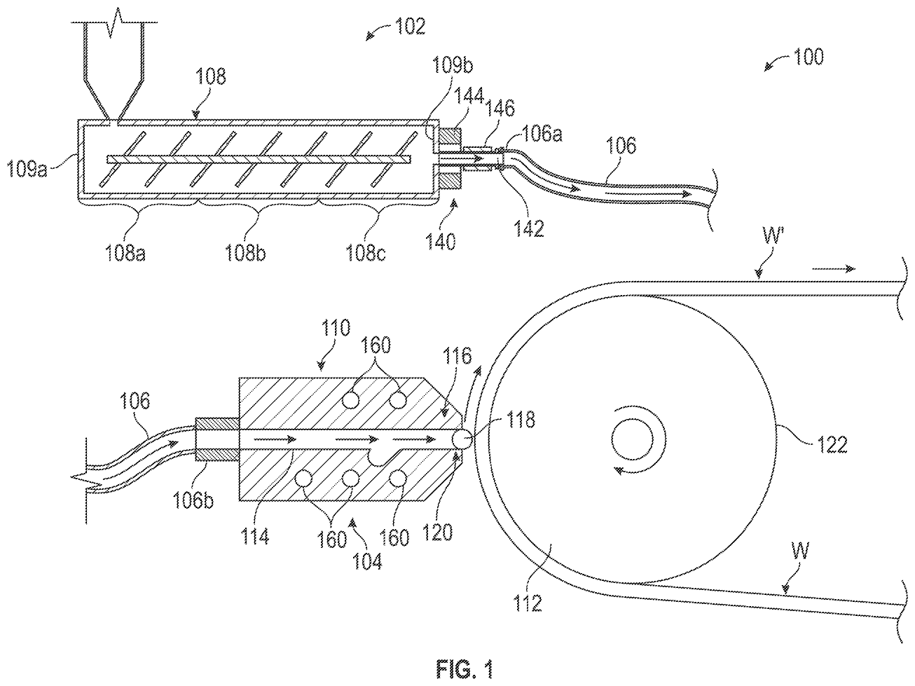

As shown in the simplified schematic view of FIG. 1, a system 100 can include a heating

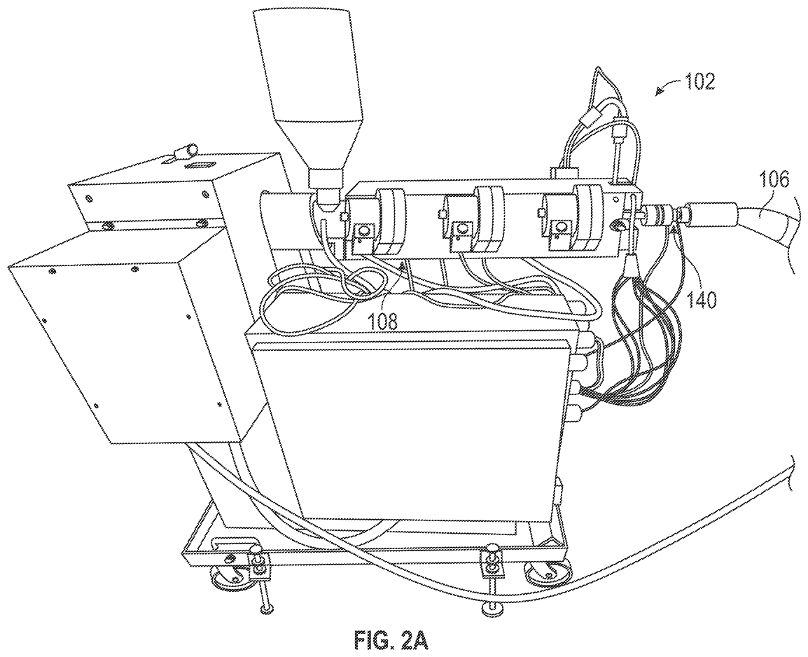

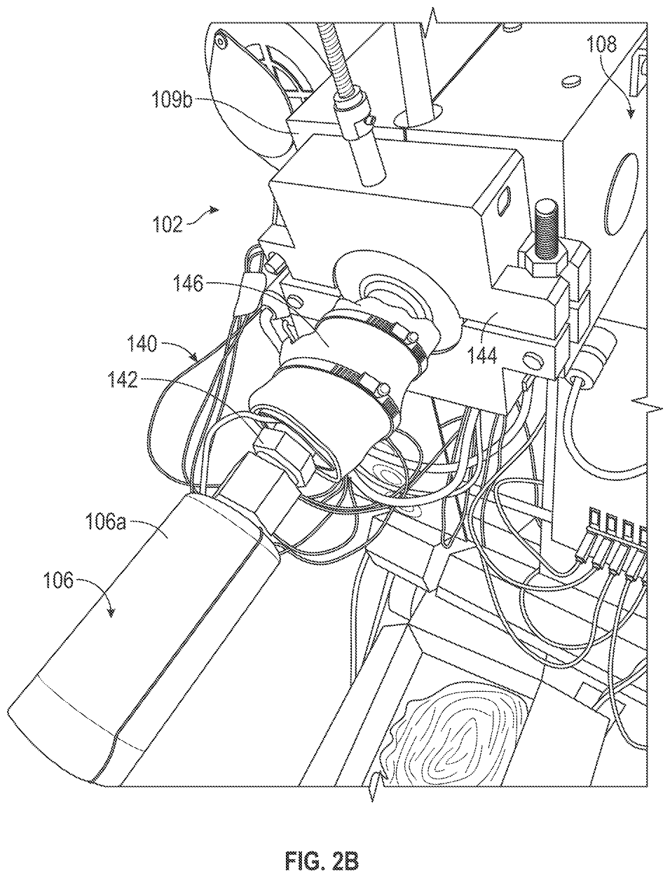

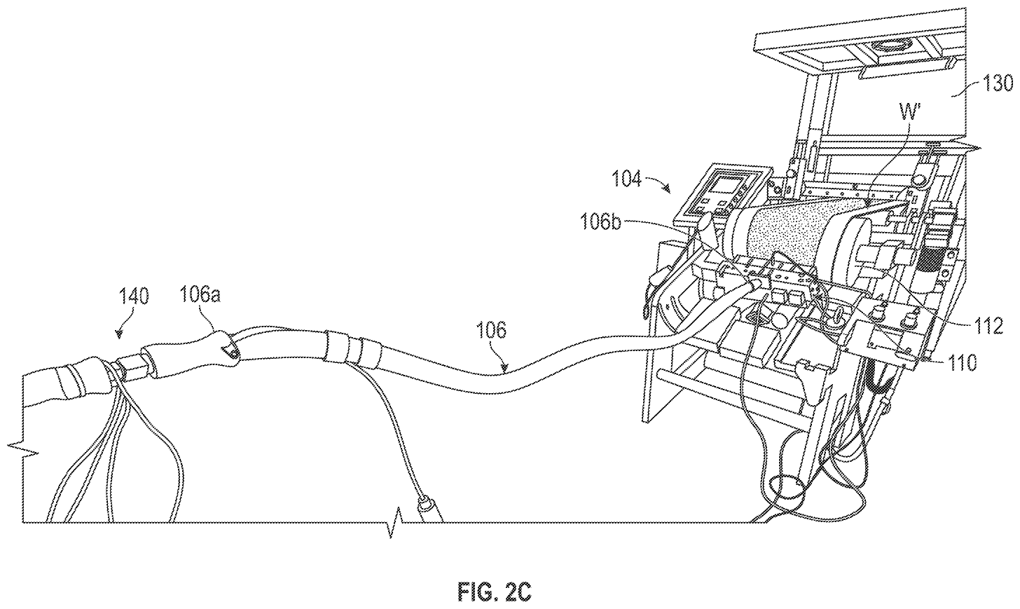

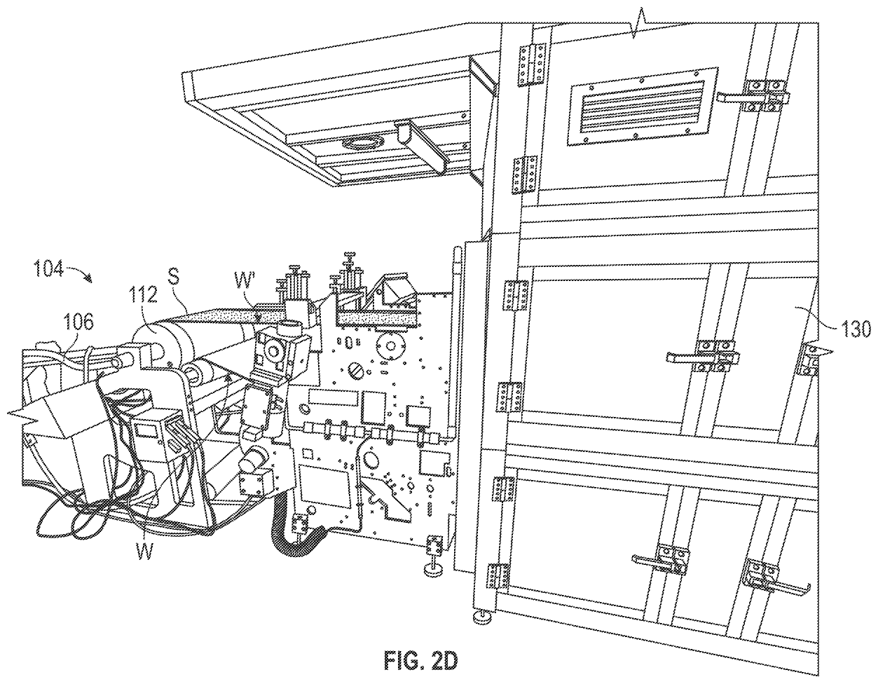

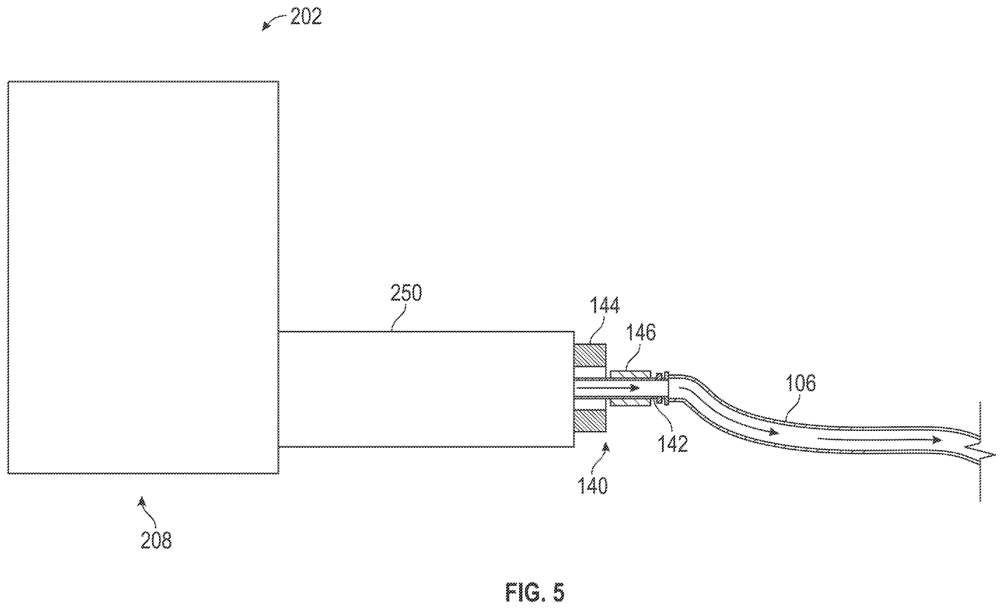

station 102 connected to (e.g., in fluid communication with) a coating station 104 by a heated hose 106. In the illustrated embodiments, the heating station 102 (FIGS. 1, 2A, and 2B) can include a heating apparatus, such as a screw extruder 108 that can heat a coating material to a pre-determined temperature within its operating temperature window (e.g., to melt the coating material and achieve a desired viscosity) and move the coating material through the heated hose 106 to the coating station 104. In embodiments, the extruder 108 can have multiple heating zones (e.g., three heating zones, such as a first heating zone 108a, a second heating zone 108b, and a third heating zone 108c, or any suitable number of heating zones), such as for gradually increasing the temperature of the coating material as it is moved from an upstream end 109a in communication with a hopper through the extruder to an output end 109b by the screw (e.g., each zone after the first can have a higher temperature than the previous zone(s)). In an exemplary embodiment, the extruder 108 can have a 1.25-inch diameter screw with a 24 to 1 ratio of length to diameter or can have any suitable dimensions. For example, the extruder 108 can be a Killion KL-125 Extruder available from Davis-Standard of Pawcatuck, CT. In alternative embodiments, the extruder 108 could be replaced by a melt tank 208 (schematically shown in FIG. 5) connected to the heated hose 106. For example, a Nordson VersaBlue 25-L hot- melt tank available from Nordson EDI of Chippewa Falls, WI, could be used. The screw extruder 108 and/or other features of the heating station 102 could be otherwise shaped, arranged, positioned, and/or configured without departing from the disclosure.

As schematically shown in FIG. 1, the heated hose 106 can be connected to the output end 109b of the extruder 108 by a connector assembly 140 (FIGS. 1-2B). For example, an upstream end 106a of the heated hose 106 can be secured to an adaptor 142 (e.g., via threaded connection, a snap fit connection, or other suitable connection), which can be mounted onto the output end 109b of the extruder 108 by a clamp ring 144. In the illustrated embodiments, the adaptor 142 can be heated by an adapter heater 146, such as a heat exchanger (e.g., moving a working fluid through a heat exchanger extending at least partially around the adapter 142), with an electric heater, and/or with any suitable heater. Further, the clamp ring 144 can include a heater (e.g., an electric heater, heat exchanger, etc.) for heating the clamp ring 144 during operation. In embodiments, the heated hose 106 can include a heater extending at least partially around the circumference of the hose along at least a portion of the length of the hose (e.g., around substantially the entire circumference of the hose and along substantially the entire length of the hose). In exemplary embodiments, the hose heater can be a heat exchanger, an electric heater, and/or any other suitable heater. In embodiments, the heated hose 106, the adapter 142 and the adapter heater 146, the clamp ring 144, and/or other portions of the system 100 could be surrounded by an insulating material. The heated hose 106 and/or the connector assembly 140 could be otherwise shaped, arranged, positioned, and/or configured without departing from the disclosure.

As shown in FIGS. 2C and 2D, the coating station 104 can include a hot-melt slot die 110 connected to a downstream end 106b of the heated hose 106 and a roller 112 positioned adjacent the slot die 110. In embodiments, the downstream end 106b of the heated hose 106 can be connected to the slot die 110, such as by a threaded connection, a snap fit connection, and/or other suitable connectors. In an example, the slot die can be a Nordson 400 mm UltraCoat V die with a rotary rod assembly available from Nordson EDI of Chippewa Falls, WI. As schematically shown in FIG. 1, the slot die 110 can include one or more internal passageways 114 (e.g., a narrow slot between the upper and lower parts of the slot die) in communication with the heated hose 106 and a die outlet 116. In embodiments, the die outlet 116 can include a rotary rod 118 of a rotary rod assembly 120 (FIGS. 1 and 3-4B). As schematically shown in FIG. 1, the slot die 110 can be heated with a fluid pumped through heat transfer passages 160 extending in the die and/or with electric heaters, cartridge heaters, and/or with other suitable features, for example. The slot die 110 could be otherwise shaped, arranged, positioned, and/or configured without departing from the disclosure.

As shown in FIGS. 1, 2C, 2D, 4A, and 4B, the roller 112 can guide a web of material W so that a surface S of the web W moves past the die outlet 116, such as so that the web W is moving generally upwardly as it moves past the die outlet 116. For example, the roller 112 can be a portion of a conveyor for the web W. In exemplary embodiments, the web W can be a substrate such as a paper-based substrate for being coated with the coating material. In the illustrated embodiments, the roller 112 can be positioned so that the web W is at least partially in contact with the rotary rod 118 as the web W moves along an outer surface 122 of the roller 112. In embodiments, the roller 112 and other conveying features for the web of material W can have a working width of 19.7 inches (500 mm) and a line speed of 1-200 ft/min (1-60 m/min). The roller 112 and/or the web conveyor in general could be otherwise shaped, arranged, positioned, and/or configured without departing from the disclosure.

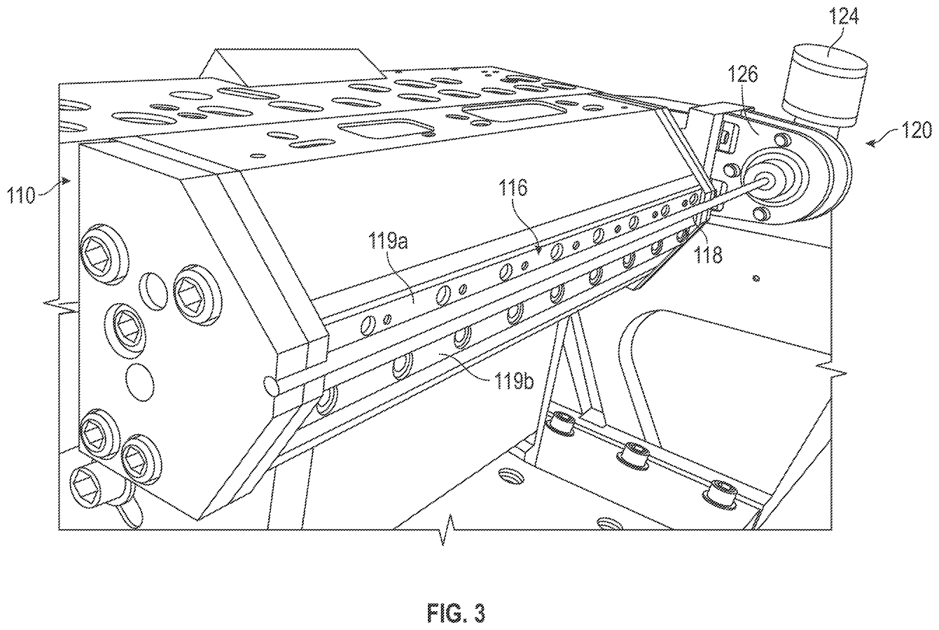

As shown in FIG. 3, the rotary rod assembly 120 can include a motor 124 and a gear box

or gear reducer 126 mounted at an end of the rotary rod 118 for turning the rotary rod. In the illustrated embodiment, the gear box 126 and motor 124 can be mounted to the body of the slot die 110 to maintain precise alignment of the rotary rod. In embodiments, the rotary rod 118 can be supported along the die outlet 116 with rotary rod inserts 119a, 119b mounted to the slot die 110 along the die outlet 116 (e.g., above and below the rotary rod 118). In exemplary embodiments, each of the rod inserts 119a, 119b can include a coating for wear resistance between the rotary rod 118 and the inserts 119a, 119b and/or the rotary rod 118 can be supported on one or more bearings, bushings, and/or other suitable features. The rotary rod assembly 120 could be otherwise shaped, arranged, positioned, and/or configured without departing from the disclosure.

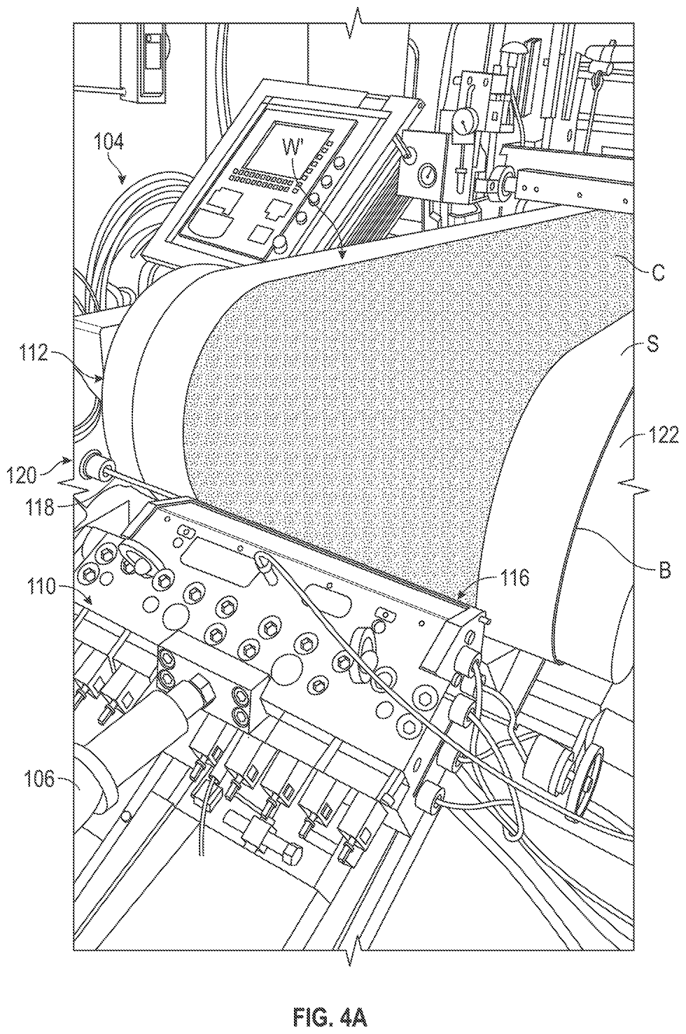

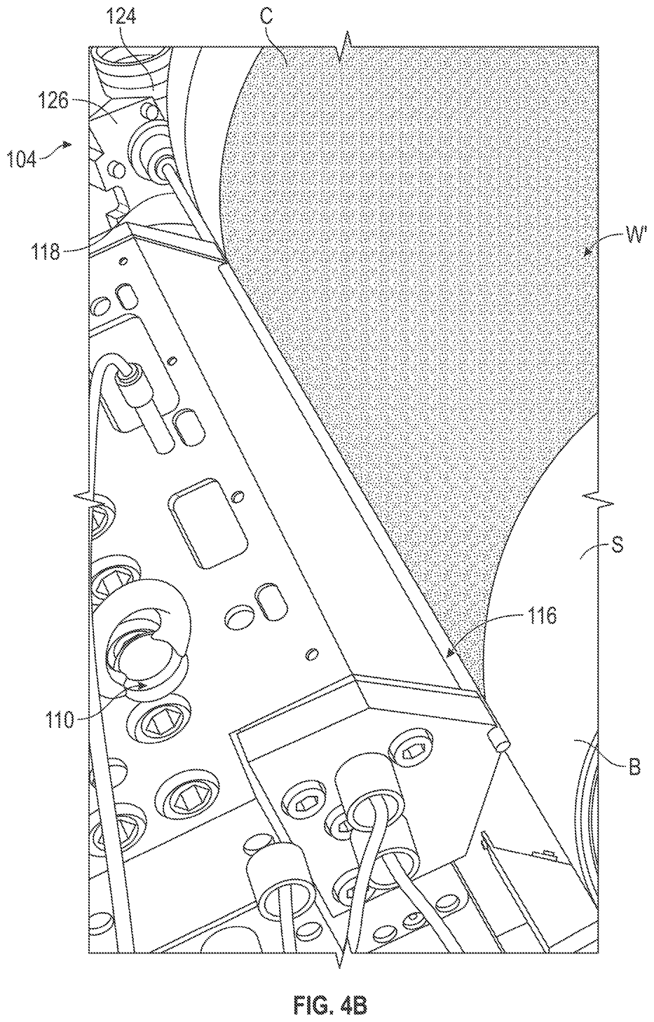

In embodiments, the rotary rod 118 can be turned (e.g., in the opposite direction that the roller 112 is turned) so that the coating material moves along the surface of the rotary rod 118 as it is pushed through the die outlet 116. The coating material can move on the rotary rod 118 as it turns until the coating material comes into contact with the surface S of the web W so that the coating material is transferred onto the surface S to form a coated web W′ (FIGS. 4A and 4B), which can include a substrate or base layer B (e.g., the uncoated web W) and a coating C (e.g., the coating material applied to the base layer B). In embodiments, the coating thickness can be adjusted by modifying the ratio of the line speed to the delivery speed of the slot die 110 and/or the coating thickness can be maintained when speeding up the line speed by speeding up the delivery rates to maintain the ratio. For example, factors that can be adjusted to affect the thickness of the coating C include the screw speed of the extruder 108 (e.g., the speed that the coating material is moved through the hose 106 and the slot die 110), the rotational speed of the rotary rod 118 (e.g., relative to the speed of the roller 112), the temperature of the extruder 108, the connector assembly 140, the hose 106, and/or the slot die 110, etc.

As shown in FIGS. 2D and 4A, the coated web W′ can be moved from the roller 112 at the

coating station 104 to a dryer unit 130 (e.g., a Coatema 120-inch 2-zone dryer with a maximum drying temperature of 455° F. (about 235° C.) available from Coatema® Coating Machinery GmbH of Dormagen, Germany, an infrared heater, and a UV curing unit, for example). Subsequently, the coated web W′ can be further processed (e.g., cooled and/or further formed into a packaging material and/or packaging construct) and/or prepared for storage and/or transportation (e.g., rewrapped on a roll).

In embodiments, the system 100 and method can apply a continuous, uniform, nonporous thermoplastic biodegradable polymer coating to a web through a hot-melt slot die. For example, a biodegradable thermoplastic polymer coating can be applied through a contact wiping method of molten material passed through a hot-melt slot die directly to a web. The system 100 and method could be otherwise configured without departing from the disclosure.

For example, in another embodiment of the disclosure schematically shown in FIG. 5, the system 200 can be similar to the system 100 of the prior embodiments. As schematically shown in FIG. 5, the system 200 can include an alternative heating station 202 wherein the heating apparatus is a hot melt tank 208 with a pump 250. In embodiments, the melt tank 208 can heat the coating material to melt it and bring it to the operating temperature. The pump 250 can be in fluid communication with the melt tank and can be connected to the heated hose 106 by the connector assembly 140 and/or by another connector. In embodiments, the pump 250 can be operated to move the coating material from the melt tank 208 through the heated hose 106 and the slot die 110 to the web W. The melt tank 208 and/or the pump 250 could be otherwise configured without departing from the disclosure.

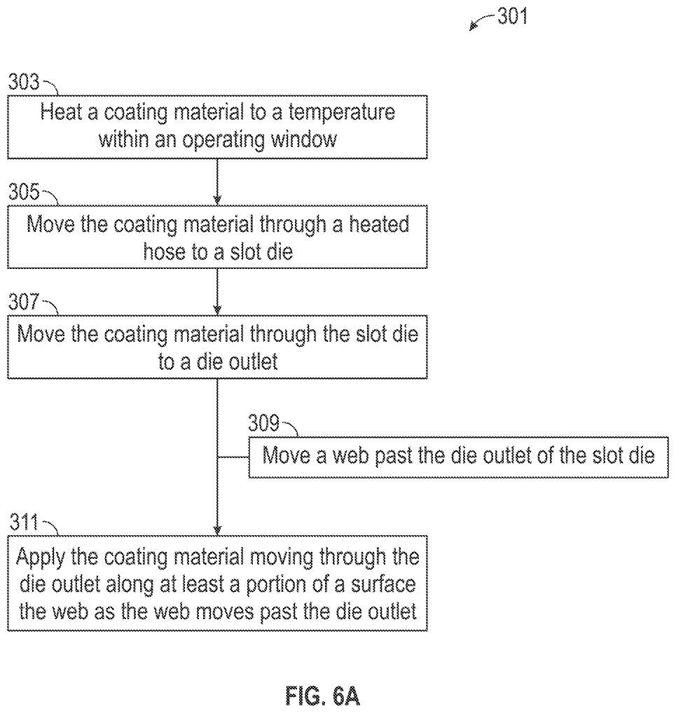

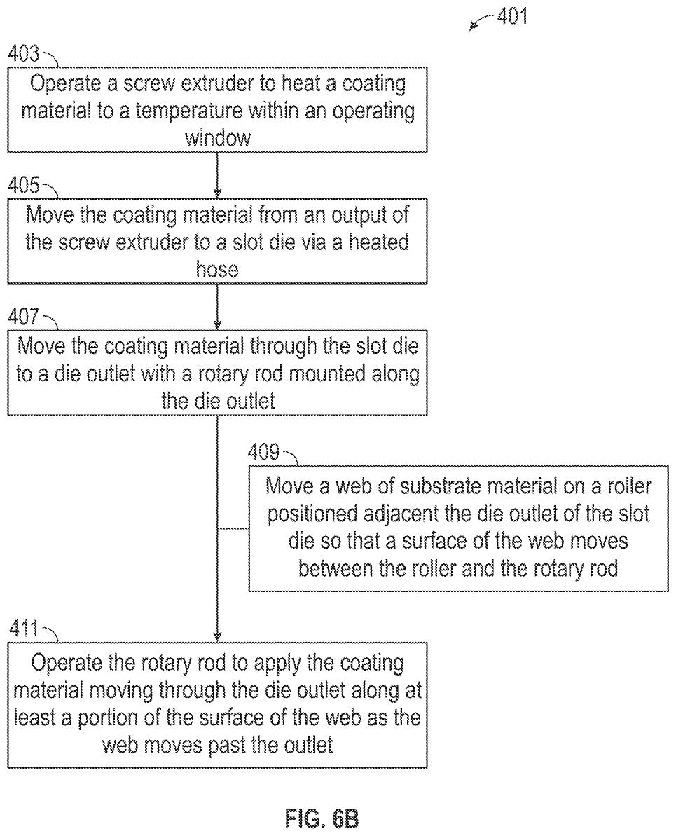

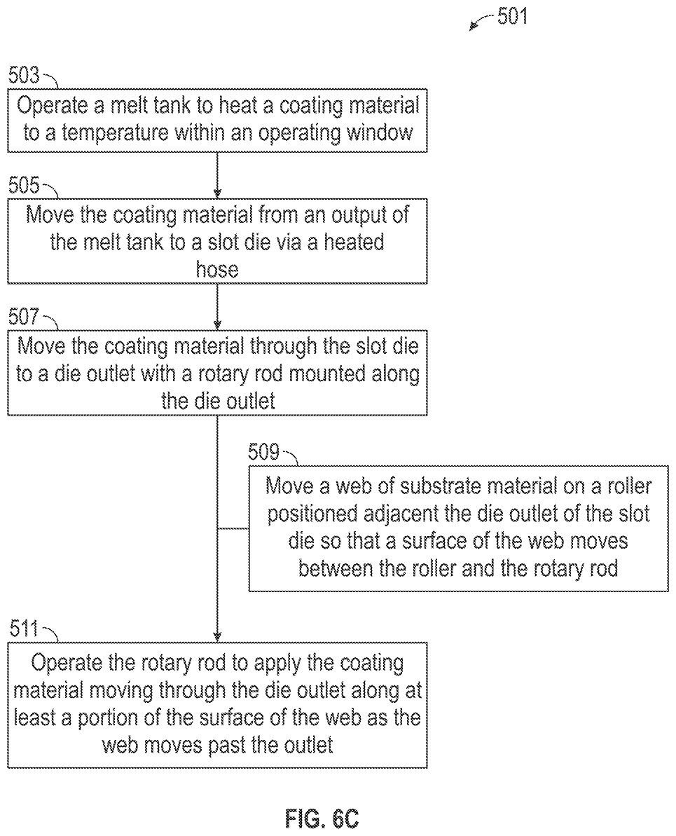

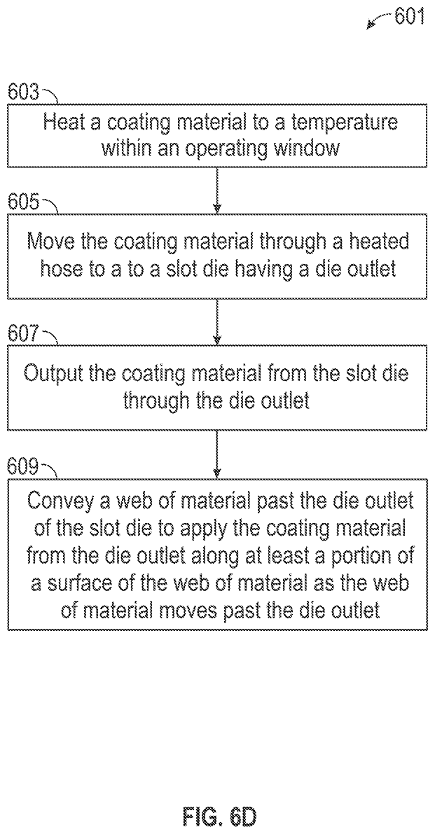

As shown in FIG. 6A, a method 301 of operating the systems of the illustrated embodiments of the disclosure can include a step 303 of heating a coating material to a temperature within an operating window, a step 305 of moving the coating material through a heated hose 106 to a slot die 110, and a step 307 of moving the coating material through the slot die 110 to a die outlet 116. A step 309 of the method 301 can include moving a web W past the die outlet 116 of the slot die 110, and a step 311 can include applying the coating material moving through the die outlet 116 along at least a portion of a surface S of the web W as the web W moves past the die outlet 116.

In an embodiment show in FIG. 6B, a method 401 can include a step 403 of operating a screw extruder 108 to heat a coating material to a temperature within an operating window, a step 405 of moving the coating material from an output end 109b of the screw extruder 108 to a slot die 110 via a heated hose 106, and a step 407 of moving the coating material through the slot die 110 to a die outlet 116 with a rotary rod 118 mounted along the die outlet 116. A step 409 of the method 401 can include moving a web W of a substrate material B on a roller 112 positioned adjacent the die outlet 116 of the slot die 110 so that a surface of the web W moves between the roller 112 and the rotary rod 118, and a step 411 can include operating the rotary rod 118 to apply the coating material moving through the die outlet 116 along at least a portion of the surface S of the web W as the web W moves past the die outlet 116.

In an embodiment show in FIG. 6C, a method 501 can include a step 503 of operating a melt tank 208 to heat a coating material to a temperature within an operating window, a step 505 of moving the coating material from an output of the melt tank 208 to a slot die 110 via a heated hose 106, and a step 507 of moving the coating material through the slot die 110 to a die outlet 116 with a rotary rod 118 mounted along the die outlet 116. A step 509 of the method 501 can include moving a web W of a substrate material B on a roller 112 positioned adjacent the die outlet 116 of the slot die 110 so that a surface of the web W moves between the roller 112 and the rotary rod 118, and a step 511 can include operating the rotary rod 118 to apply the coating material moving through the die outlet 116 along at least a portion of the surface S of the web W as the web W moves past the die outlet 116.

In an embodiment show in FIG. 6D, a method 601 of operating the systems of the illustrated embodiments of the disclosure can include a step 603 of heating a coating material to a temperature within an operating window, a step 605 of moving the coating material through a heated hose 106 to a slot die 110 having a die outlet 116, and a step 607 of outputting the coating material from the slot die 110 through the die outlet 116. A step 609 of the method 601 can include conveying a web of material W past the die outlet 116 of the slot die 110 to apply the coating material from the die outlet 116 along at least a portion of a surface S of the web of material W as the web of material W moves past the die outlet 116.

In a first example, PHA (e.g., DAN-03571 available from Danimer Scientific of Bainbridge, GA) can be the coating material processed in the system 100 of the first embodiment. In this first example, the system 100 can have a melt profile in which the extruder 108 has a screw speed of 520 RPM and is heated to 350° F. (about 177° C.) in its first zone 108a, to 370° F. (about 188° C.) in its second zone 108b, and to 390° F. (about 199° C.) in its third zone 108c; the clamp ring 144 is heated to 390° F. (about 199° C.); the adapter 146 is heated to 380° F. (about 193° C.); and each of the heated hose 106 and the slot die 110 is heated to 185° C. (about 365° F.).

In the first example, the line speed (e.g., the speed that the web W is moved past the die outlet 116) is 16 m/min. The coated web W′ produced in this first example had a thickness of 0.5 mil with a coating measured at approximately 11 μm (about 0.43 mil) by gauge.

In a second example, PHA with PLA (e.g., DAN-03901 available from Danimer

Scientific of Bainbridge, GA) can be the coating material processed in the system 200 of the second embodiment. In this second example, the system 200 can have a melt profile in which the pot temperature of the melt tank 208 can be set to 200° C. (about 392° F.), the heated hose 106 is heated to 190° C. (about 374° F.) and the slot die 110 is heated to 185° C. (about 365° F.). In the second example, pump speed was metered relative to the line speed. When the line speed was set at 5 m/min and the pump 250 was set to 3.7 rotations/min, the coating C had a thickness of approximately 25 μm (about 1 mil), gauge. Increasing the line speed to 8 m/min with the same pump speed resulted in a coating thickness of approximately 6μm to 12 μm (about 0.24 mil to mil), gauge; however, it is noted that slowing the rotation of the rotary rod 118 improved the uniformity of the coating with the system 200 set at these speeds. When the line speed was set at 15 m/min and the pump 250 was set to 6.5 rotations/min, the coating C had a thickness of approximately 11 1 μm (about 0.43 mil), gauge. Similarly, when the line speed was set at 20 m/min and the pump 250 was set to 8.8 rotations/min, the coating C had a thickness of approximately 11 μm (about 0.43 mil), gauge.

The foregoing description of the disclosure illustrates and describes various exemplary

embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A method for forming a coated material, the method comprising:
heating a coating material to a temperature within an operating window;
moving the coating material through a heated hose to a slot die having a die outlet;
outputting the coating material from the slot die through the die outlet; and
conveying a web of material past the die outlet of the slot die to apply the coating material from the die outlet along at least a portion of a surface of the web of material as the web of material moves past the die outlet.

2. The method of claim 1, further comprising heating the heated hose to maintain the temperature of the coating material in the heated hose within the operating window.

3. The method of claim 2, wherein the operating window for the temperature of the coating material is approximately 10° C.

4. The method of claim 2, wherein the heating the heated hose comprises heating the heated hose to a temperature of approximately 185° C. to approximately 190° C.

5. The method of claim 2, wherein the heated hose is attached to a heating apparatus via a connector assembly, the heating the coating material comprising operating the heating apparatus to heat the coating material, and the method further comprises heating at least a portion of the connector assembly to maintain the temperature of the coating material in the connector assembly within the operating window.

6. The method of claim 5, further comprising heating the slot die to maintain the temperature of the coating material in the slot die within the operating window.

7. The method of claim 1, further comprising heating the slot die to maintain the temperature of the coating material in the slot die within the operating window.

8. The method of claim 1, wherein a rotary rod extends along the die outlet, and the method further comprises rotating the rotary rod during the outputting the coating material so that the coating material moves along the rotary rod as it passes through the die outlet.

9. The method of claim 8, wherein the conveying the web of material comprises moving the web of material on a roller positioned relative to the die outlet so that the web of material is in contact with the roller and the rotary rod as the web of material passes the die outlet.

10. The method of claim 1, wherein the heating the coating material comprises heating the coating material with a screw extruder.

11. The method of claim 10, wherein the heating the coating material with the screw extruder comprises heating at least a portion of the screw extruder to approximately 200° C., and the method further comprises heating the heated hose to approximately 185° C.

12. The method of claim 11, further comprising heating the slot die to approximately 185° C.

13. The method of claim 1, wherein the heating the coating material comprises heating the coating material with a hot melt tank.

14. The method of claim 13, wherein the heating the coating material with the hot melt tank comprises operating the melt tank to achieve a pot temperature of approximately 200° C., and the method further comprises heating the heated hose to approximately 175° C.

15. The method of claim 14, further comprising heating the slot die to approximately 185° C.

16. A system for forming a coated material, the system comprising:
a heating station for heating a coating material to a temperature within an operating window;
a slot die comprising a die outlet for outputting the coating material from the slot die;
a heated hose in fluid communication with the heating station and the slot die for moving the coating material from the heating station to the slot die; and
a conveyor positioned relative to the die outlet of the slot die for conveying a web of material past the die outlet.

17. The system of claim 16, wherein the heated hose is heated with a hose heater for maintaining the temperature of the coating material in the heated hose within the operating window.

18. The system of claim 17, wherein the operating window for the temperature of the coating material is approximately 10° C.

19. The system of claim 17, wherein the heating station comprises a heating apparatus attached to the heated hose via a connector assembly, the heating apparatus is operable to heat the coating material, and at least a portion of the connector assembly is heated to maintain the temperature of the coating material in the connector assembly within the operating window.

20. The system of claim 19, wherein the slot die comprises heating features for maintaining the temperature of the coating material in the slot die within the operating window.

21. The system of claim 16, wherein the slot die comprises heating features for maintaining the temperature of the coating material in the slot die within the operating window.

22. The system of claim 16, wherein a rotary rod extends along the die outlet, and the rotary rod is configured for rotating along the die outlet so that the coating material moves along the rotary rod as it passes through the die outlet.

23. The system of claim 22, wherein the conveyor comprises a roller, the web of material extends along a surface of the roller, and the roller is positioned relative to the die outlet so that the web of material is in contact with the roller and the rotary rod as the web of material passes the die outlet.

24. The system of claim 16, wherein the heating station comprises a screw extruder for heating the coating material and moving the coating material through the heated hose and the slot die.

25. The system of claim 24, wherein at least a portion of the screw extruder is configured for being heated to approximately 200° C., and the heated hose is configured for being heated to approximately 185° C.

26. The system of claim 16, wherein the heating station comprises a hot melt tank configured for heating the coating material.

27. The system of claim 26, wherein the hot melt tank is operable to achieve a pot temperature of approximately 200° C., and the heated hose is configured for being heated to approximately 175° C.
